(19) United States
(12) Patent Application Publication
(10) Pub. No.: US 2021/0224716 A1
(43) Pub. Date: Jul. 22, 2021

(54) EXPERTISE SCORE VECTOR BASED WORK ITEM ASSIGNMENT FOR SOFTWARE COMPONENT MANAGEMENT

(71) Applicant: International Business Machines Corporation, Armonk, NY (US)

(72) Inventors: Andrew C. M. Hicks, Wappingers Falls, NY (US); Michael Terrence Cohoon, Fishkill, NY (US); RYAN THOMAS RAWLINS, New Paltz, NY (US); MICHAEL E. GILDEIN, Wappingers Falls, NY (US)

(21) Appl. No.: 16/749,014

(22) Filed: Jan. 22, 2020

(51) Int. Cl. G06Q 10/06; G06Q 10/10

(52) U.S. Cl. CPC G06Q 10/063112; G06Q 10/101

(57) ABSTRACT

Techniques for expertise score vector based work item assignment for software component management are described herein. An aspect includes receiving a problem record corresponding to a software component. Another aspect includes determining a work item corresponding to the problem record. Another aspect includes assigning the work item to a developer based on an expertise score vector of the developer. Another aspect includes, based on completion of the work item by the developer, updating the expertise score vector of the developer

### BACKGROUND

The present invention generally relates to computer systems, and more specifically, to expertise score vector based work item assignment for software component management in a computer system.

Computer systems control almost every aspect of our life—from writing documents to controlling traffic lights. Such computer systems are controlled by software components that may be written by teams of software developers. The software components may be relatively complex, requiring relatively large numbers of developers working together to produce and maintain computer code that is executed on a computer system. Further, computer systems may be often error-prone, and thus require a testing phase in which any errors should be discovered. The testing phase is considered one of the most difficult tasks in designing a computer system. The cost of not discovering an error may be enormous, as the consequences of the error may be disastrous.

### SUMMARY

Embodiments of the present invention are directed to expertise score vector based work item assignment for software component management. A non-limiting example computer-implemented method includes receiving a problem record corresponding to a software component. The method also includes determining a work item corresponding to the problem record. The method also includes assigning the work item to a developer based on an expertise score vector of the developer. The method also includes, based on completion of the work item by the developer, updating the expertise score vector of the developer

Other embodiments of the present invention implement features of the above-described method in computer systems and computer program products.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of an example computer system for use in conjunction with one or more embodiments of an expertise score vector based work item assignment for software component management;

FIG. 2 is a flow diagram of a process for expertise score vector based work item assignment for software component management in accordance with one or more embodiments of the present invention;

FIG. 3 is a flow diagram of a process for developer training using expertise score vector based work item assignment for software component management in accordance with one or more embodiments of the present invention; and

FIGS. 4A and 4B are block diagrams of components of a system for expertise score vector based work item assignment for software component management in accordance with one or more embodiments of the present invention.

### DETAILED DESCRIPTION

One or more embodiments of the present invention provide expertise score vector based work item assignment for software component management. An organization may produce and maintain computer software products for use on computer systems that include multiple software components. Each software component may be assigned a team of developers that are responsible for the software component. Creating software (i.e., developing) for different computer systems that implement relatively complex software components may require specialized knowledge and skills by a software developer. Such knowledge and skills may be gained through experience developing for a particular computer system and/or software component. In order to maintain relatively high quality in software that is produced by an organization, respective expertise score vectors may be maintained for each developer in an organization to identify levels of skills and component mastery for individual developers. Work items may be assigned to developers based on expertise scores that are determined based on the expertise score vectors. For example, a more experienced developer having a higher expertise score may be assigned relatively complex work items, while a less experienced developer having a lower expertise score may be assigned relatively simple work items.

Problem records may be generated based on detection of a problem with a software component. A work item may be generated based on a problem record, and the work item may be assigned to a developer so that the developer may fix the problem. Assignment of a work item corresponding to a problem record may be performed based on the expertise score vectors that are maintained for developers on a team corresponding to the software component. Usage of the expertise score vector to assign work items may ensure that problems with the software component are handled by one or more developers having appropriate skillsets and experience levels. When a work item is correctly assigned, the underlying problem may have a relatively short resolution time and a higher quality solution, due to the assigned developer's expertise.

An expertise score vector corresponding to a developer may include any appropriate developer metrics, including but not limited to component mastery metrics for any software components the developer has worked on, a language set (e.g., Java, Python, C, etc.), coding techniques, code patterns, and quality metrics regarding completed work (i.e., code contributions) by the developer. Completion of a unit of contribution by a developer to a software component may be determined based on, for example, committing of code to a code base corresponding to the software component. When a developer contributes to a software component, information regarding the code contribution may be identified, such as the programming language of the code and/or any programming techniques used in the code. The expertise score vector of a developer may track a number of commits by the developer per skill (e.g., programming language). A code contribution may be scanned (using, for example, static code analysis and/or natural language processing) to identify what the code does and any techniques that are implemented in the code contribution. For example, a developer may often write code involving particular techniques or technologies, including but not limited to recursion, loops, thread management, mutex locks, and interfacing with certain subcomponents.

Information about the type of work each developer in a team has completed may be tracked each developer's respective expertise score vector, providing a corpus of team member skills. Team member skills may be stored and/or displayed in any appropriate manner (e.g., a word bubble and/or a database), and may be used for any appropriate task, such as determining work item assignments. When a new problem record is received for a software component, the contents of the problem record may be analyzed to determine information regarding the problem. The analysis may include natural language processing (NLP) in some embodiments, and keywords in the problem record may be identified by the analysis. The determined keywords may then be compared to the developer skills on the team that owns the software component, and any matches between developers on the team and the problem record may be identified. If no matches are found for a new problem record on a particular team, other teams in the organization may be scanned for appropriate skills to handle the problem record, or multiple developers having relatively closely related skills may be assigned to work on the problem record as a group. In some embodiments, an alert may be issued to a team lead regarding a lack of matches for the problem record.

In order to enable a team to train employees in a certain skill, when a problem record is received that is related to the certain skill, multiple developers from the team may be assigned to the problem record as a group. At least one assignee in the group may be an experienced developer that has skills that match the problem record, while other developers in the group may be assigned to learn. In some embodiments, an expertise score vector may track a count of the number of defects found in code related to different skills, which may be used to determine whether a trainee is learning new skills.

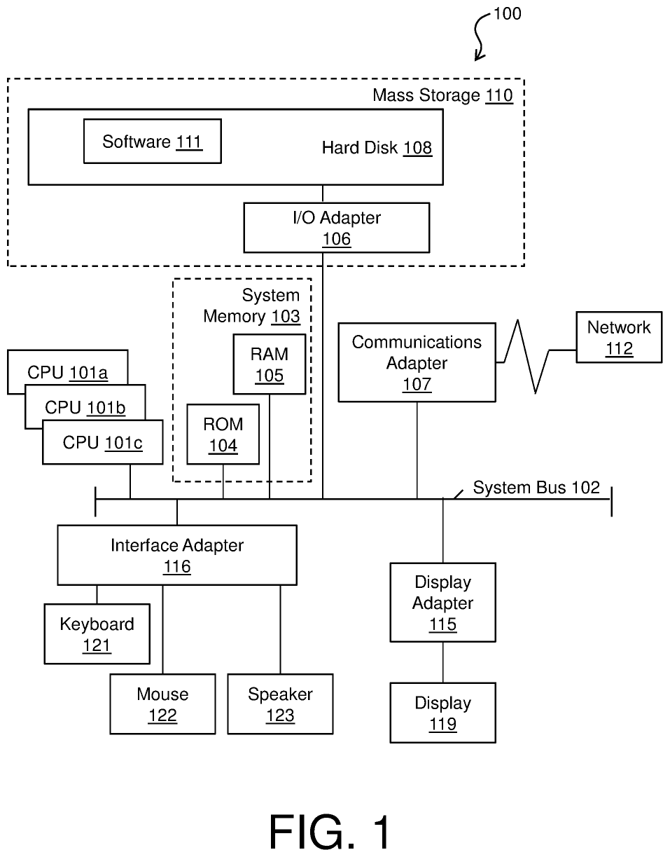

Turning now to FIG. 1, a computer system 100 is generally shown in accordance with an embodiment. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc. (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random access memory (RAM) 105. The ROM 104 is coupled to the system bus 102 and may include a basic input/output system (BIOS), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system, such as the z/OS or AIX operating system from IBM Corporation, to coordinate the functions of the various components shown in FIG. 1.

Additional input/output devices are shown as connected to the system bus 102 via a display adapter 115 and an interface adapter 116 and. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by a display adapter 115, which may include a graphics controller to improve the performance of graphics intensive applications and a video controller. A keyboard 121, a mouse 122, a speaker 123, etc. can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 1, the computer system 100 includes processing capability in the form of the processors 101, and, storage capability including the system memory 103 and the mass storage 110, input means such as the keyboard 121 and the mouse 122, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

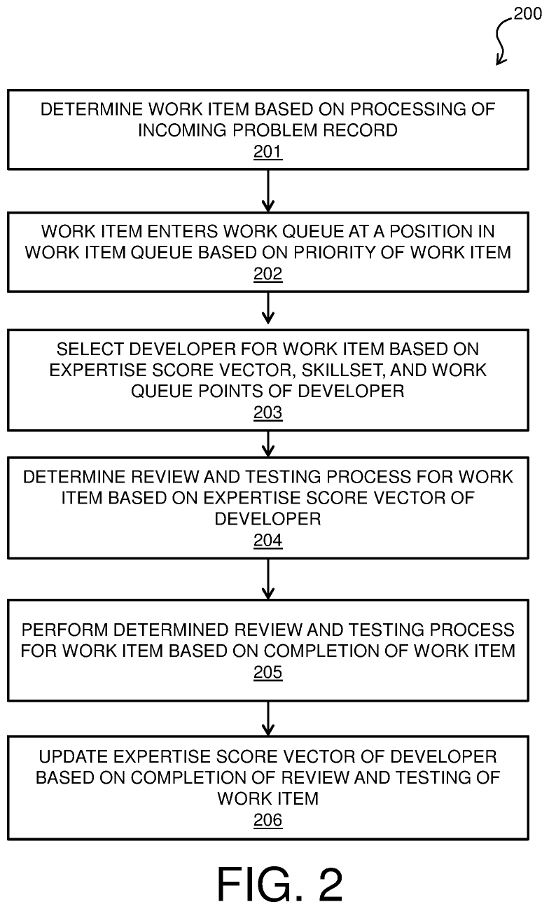

Turning now to FIG. 2, a process flow diagram of a method 200 for expertise score vector based work item assignment for software component management is generally shown in accordance with one or more embodiments of the present invention. Method 200 may be implemented in conjunction with any appropriate computer system, such as computer system 100 of FIG. 1. In block 201 of method 200, an incoming problem record is received and processed to determine a corresponding work item. The problem record may have been generated based on an underlying problem (e.g., bug) in a software component. The processing may include natural language processing (NLP) of the problem record to determine any keywords from the problem record to be included in the work item. The keywords may be any appropriate descriptor of the underlying problem corresponding to the problem record, including but not limited to a programming language, programming techniques, and/or descriptors of a computing environment in which the problem occurred. A minimum expertise score for the work item may also be determined in block 201. The minimum expertise score may be determined based on the severity and complexity of the underlying problem. The minimum expertise score may also be determined based on an amount of time the deployed code corresponding to the problem report has been in the field. For a problem report corresponding to deployed code that has been in the field a relatively long amount of time, a higher minimum expertise score may be required, as compared to a problem report corresponding to deployed code that has been in the field a relatively short amount of time. The work item may also be assigned a priority in block 201 based on a desired timeframe for completion of the work item. For example, for a work item corresponding to a major loss of functionality in a deployed software component, a high priority may be assigned. In block 202, the work item enters a work item queue corresponding to the software component. The position of the work item in the work item queue may be determined based on the priority of the work item.

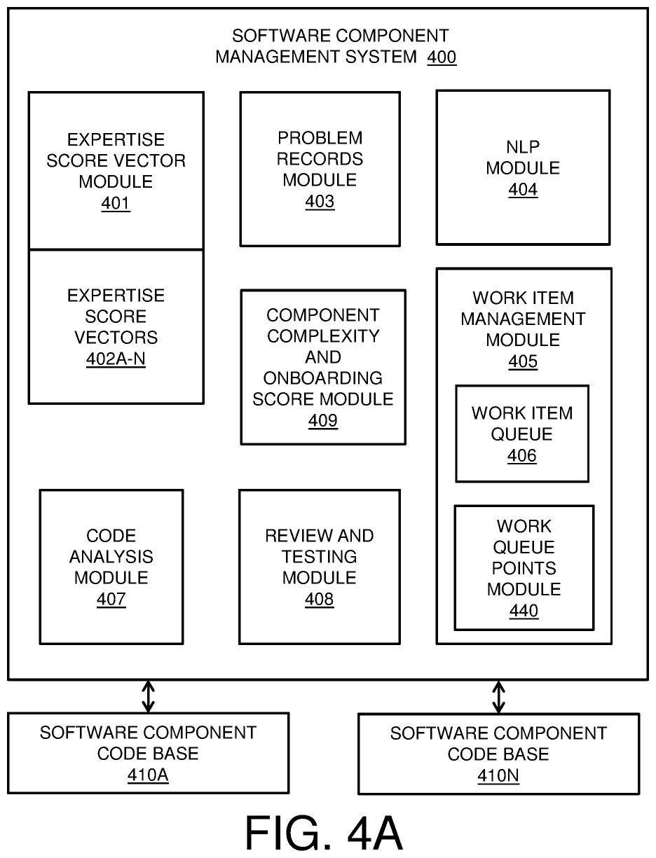

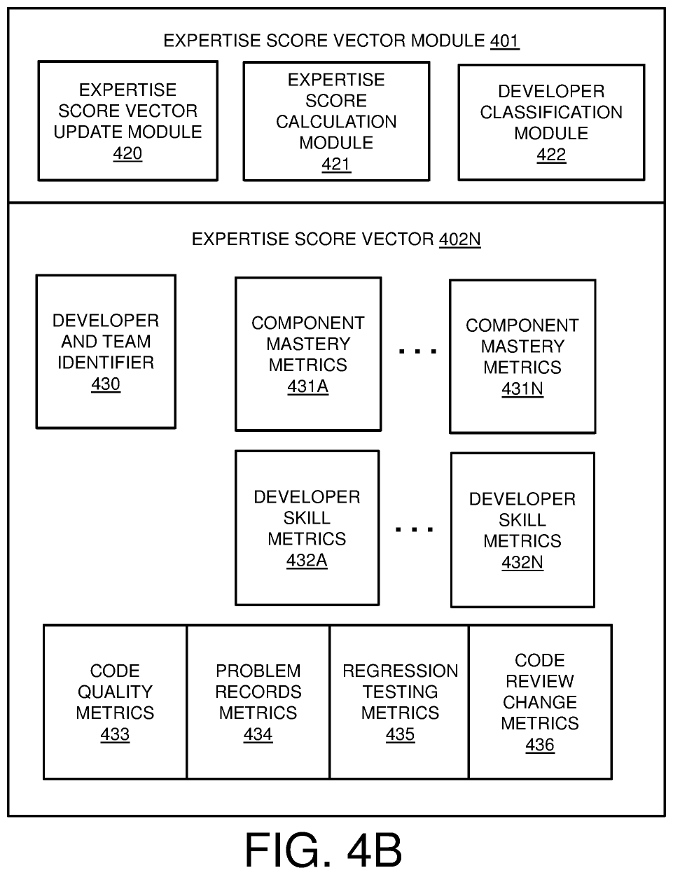

In block 203, a developer from the team corresponding to the software component is selected for the work item based on an expertise score vector of the developer. The developer may be selected in block 203 based on any appropriate information from the expertise score vector, such as an overall component mastery metric and a skillset of the developer. An expertise score may be determined for the developer in block 203 based on a subset of fields relevant to the work item in the expertise score vector (e.g., metrics directly related to a software component and/or skill relevant to the work item); a magnitude of a vector including the subset of fields may be used to determine the expertise score. The expertise scores of all developers on a team may be compared to a minimum expertise score that was determined for the work item in block 201, and a developer having an expertise score higher than the minimum expertise score may be selected in block 203. An embodiment of an expertise score vector is discussed in further detail below with respect to FIG. 4B. Information about the type of work each developer in a team has completed may be tracked using each developer's respective expertise score vector, providing a corpus of team member skills that may be used to select a developer for the work item in block 203. Team member skills may be stored and/or displayed in any appropriate manner (e.g., a word bubble and/or a database). In some embodiments of block 203, keywords that were determined by NLP in block 201 may be compared to the developer skills on the team that owns the software component corresponding to the work item, and any matches between developers on the team and the work item may be identified. If no matches are found for a new work item on a particular team in block 203, other teams in the organization may be scanned for appropriate skills to handle the work item, or multiple developers having relatively closely related skills may be assigned to work on the work item as a group. In some embodiments, an alert may be issued to a team lead regarding a lack of matches for the work item. In some embodiments, the selected developer may refuse the assignment of the work item in block 203; in such embodiments, another developer having skills that are relatively close to the work item may be selected. In some embodiments, multiple developers may be assigned to a single work item in block 203 based on their respective expertise scores.

The work item may also be assigned in block 203 based on each developer's currently assigned workload, which may be quantified by a work queue points value. A work item management module may track any in-progress work items that are currently assigned to each developer on a team. For two developers on a team that match a new work item, the new work item may be assigned to the developer having a smaller work queue and corresponding lower number of work queue points. Work queue points may be determined for a developer based on the developer's currently assigned workload. The work queue points may be used to determine respective workloads of developers on a team, and work items may be assigned to specific developers on the team based on the developer's respective work queue points in block 203.

In block 204, a review and testing process for the work item is determined based on the expertise score vector(s) of the assigned developer(s). For example, if a developer that was selected in block 203 is a less experienced developer, or has a relatively low overall component mastery metric for a software component or skill corresponding to the work item, a more rigorous code review and testing process (including, for example, additional review or testing iterations, and/or more experienced reviewers or testers) may be determined to be necessary for the work item. For a developer having higher component mastery or skill metrics, a less rigorous code review and testing process may be determined. In block 205, based on the developer completing the work item, the review and testing process that was determined in block 204 is applied to the code that the developer submitted corresponding to the work item. In block 206, the developer's expertise score vector is updated based on completion of review and testing of the code corresponding to the work item. For example, in block 206, the developer's component mastery metrics for the software component corresponding to the work item may be updated to a value corresponding to a higher developer tier based on relatively fast completion of relatively high quality code corresponding to the work item, and/or additional skills may be added to the developer's skillset metrics in the expertise score vector. For any errors detected in the committed code, one or more metrics in the developer's expertise score vector may be decreased in block 206. Embodiments of method 200 may be implemented in software component management system 400 of FIGS. 4A-B, which is discussed in further detail below.

The process flow diagram of FIG. 2 is not intended to indicate that the operations of the method 200 are to be executed in any particular order, or that all of the operations of the method 200 are to be included in every case. Additionally, the method 200 can include any suitable number of additional operations.

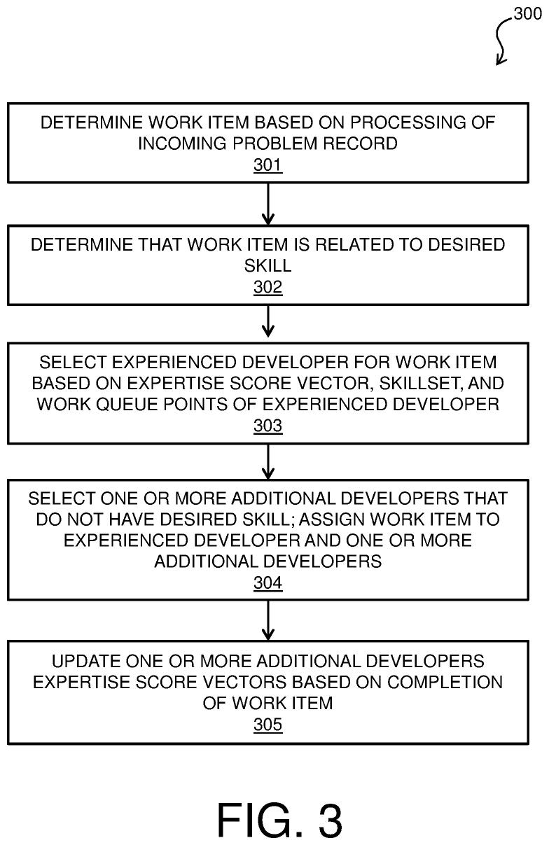

FIG. 3 illustrates a process flow diagram of a method 300 for developer training using expertise score vector based work item assignment for software component management that is generally shown in accordance with one or more embodiments of the present invention. Method 300 may be implemented in conjunction with any appropriate computer system, such as computer system 100 of FIG. 1. In block 301 of FIG. 3, a work item is determined based on processing of an incoming problem record, and is entered into a work item queue corresponding to a software component. Block 301 may be performed as described above with respect to blocks 201 and 202 of FIG. 2.

In block 302, it is determined that the work item is related to a desired skill. For example, a manager may desire that developers on a particular team gain knowledge regarding a particular programming language, technique, and/or computing environment. The determination of block 302 may be made based on any keywords that were determined by the processing of the problem record in block 301. In block 303, an experienced developer having skills that match the work item, including the desired skill, is selected based on the experienced developer's expertise score vector. The selection of block 303 may be performed as described above with respect to block 203.

In block 304, one or more additional developers on the team that do not have the desired skill are selected and assigned to work on the work item with the experienced developer that was selected in block 303. The determination of any additional developers that do not have the desired skill may be made based on skills that are not included the developer's respective expertise score vectors, or based on the desired skill indicating a relatively low level of mastery in the developer's respective expertise score vectors.

In block 305, based on completion of the work item (e.g., code is committed into the software component code base corresponding to the work item), the expertise score vectors of the one or more additional developers are updated. Committed code corresponding to the work item may be reviewed and tested in block 305 to determine code quality. An amount of time in development for the committed code may also be determined, and a number of units of contribution (e.g., number of lines of code) may be determined to update component mastery metrics in the expertise score vector in block 305. In some embodiments, the expertise score vector may track a count of a number of defects found in code related to the desired skill, which may be used to determine whether a trainee developer is progressing in learning the desired skill.

The process flow diagram of FIG. 3 is not intended to indicate that the operations of the method 300 are to be executed in any particular order, or that all of the operations of the method 300 are to be included in every case. Additionally, the method 300 can include any suitable number of additional operations.

Turning now to FIG. 4A, a software component management system 400 that includes an expertise score vector is generally shown in accordance with one or more embodiments of the present invention. Software component management system 400 may be implemented in conjunction with any appropriate computer system(s), including but not limited to computer system 100 of FIG. 1. Software component management system 400 is in communication with software component code bases 410A-N, which each include computer code written by one or more developers on teams corresponding to various software components. The software component management system 400 includes an expertise score vector module 401, which may maintain a respective expertise score vector of expertise score vectors 402A-N for each developer across various teams in the organization. Expertise score vector module 401 and expertise score vectors 402A-N are discussed in further detail below with respect to FIG. 4B.

Software component management system 400 includes a problem records module 403, which receives and manages problem records (e.g., bug reports) regarding the software component code bases 410A-N. NLP module 404 performs analysis of problem records that are received by problem records module 403 and may, for example, output keywords that are identified in a problem record to work item management module 405. Work item management module 405 creates work items based on problem records that are received by problem records module 403. The work items may be created by work item management module 405 based on keywords that were identified by NLP module 404 in some embodiments. Work item management module 405 may also create work items based on new feature requests for the software components corresponding to software component code bases 410A-N. Created work items are placed in a work item queue 406 by work item management module 405. The work items in work item queue 406 are assigned to developers by work item management module 405 based on input from expertise score vector module 401 and data from the developers' respective expertise score vectors 402A-N. Work queue points module 440 may track a respective workload for each developer that is currently assigned to any work items in work item queue 406.

When new code is committed by a developer into any of software component code bases 410A-N, code analysis module 407 may review the new code to determine a code quality of the new code. Review and testing module 408 may determine and apply a review and testing process to new code, and may also assign one or more developers to the review and testing process based on expertise score vectors 402A-N. Review and testing module 408 may also provide data regarding the review and testing of code to expertise score vector module 401.

Component complexity and onboarding score module 409 may determine a relative component complexity and an onboarding score for each software component corresponding to software component code bases 410A-N. Component complexity and onboarding score module 409 may operate based on component mastery metrics 431A-N and developer classification module 422 of FIG. 4B, which are discussed below.

Software component management system 400 may implement embodiments of method 200 of FIG. 2. For example, an incoming problem record may be received by problem records module 403 and processed by NLP module 404 to determine keywords in the problem record in block 201. A work item may be created by work item management module 405 and entered into work item queue 406 in block 202. A developer may be chosen for the work item by expertise score vector module 401 based on the developer's associated expertise score vector 402N in block 203. In block 204, a review and testing process may be determined for the work item by review and testing module 408, and the determined review and testing process may be applied to completed code corresponding to the work item by review and testing module 408 in block 205. In block 206, the developer's expertise score vector 402N may be updated by expertise score vector module 401 based on the review and testing of the completed code.

Software component management system 400 may implement embodiments of method 300 of FIG. 3. For example, an incoming problem record may be received by problem records module 403 and processed by NLP module 404 to determine keywords in the problem record in block 301. A work item may be created by work item management module 405 and entered into work item queue 406 in block 302, and work item management module 405 may determine that the work item relates to a desired skill. An experienced developer may be chosen for the work item based on data from expertise score vector module 401 and the developer's associated expertise score vector 402N in block 303. In blocks 304, an additional developer that does not have the desired skill may be selected based on the additional developer's associated expertise score vector 402A. In block 305, the additional developer's expertise score vector 402A may be updated by expertise score vector module 401 based on the review and testing of the completed code corresponding to the work item.

It is to be understood that the block diagram of FIG. 4A is not intended to indicate that the system 400 is to include all of the components shown in FIG. 4A. Rather, the system 400 can include any appropriate fewer or additional components not illustrated in FIG. 4A (e.g., additional memory components, embedded controllers, functional blocks, connections between functional blocks, modules, inputs, outputs, etc.). Further, the embodiments described herein with respect to system 400 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

Turning now to FIG. 4B, an expertise score vector module 401 is generally shown in accordance with one or more embodiments of the present invention. Expertise score vector module 401 of FIG. 4B corresponds to expertise score vector module 401 of FIG. 4A, and manages a plurality of expertise score vectors 402A-N. Expertise score vector module 401 includes an expertise score vector update module 420, which may update any field in an expertise score vector 402N based on data from problem records module 403, work item management module 405, code analysis module 407, and review and testing module 408 in software component management system 400.

Expertise score calculation module 421 may determine an expertise score for a developer based on the developer's expertise score vector 402N. An expertise score may be determined based on any appropriate subset of the fields in expertise score vector 402N, and the various fields in expertise score vector 402N may each be given any appropriate weight in calculating an expertise score. An expertise score may be calculated by expertise score calculation module 421 for a specific skill in some embodiments, such that only fields related to the specific skill are used to calculate the expertise score for the specific skill. In some embodiments, an expertise score that is calculated for a specific skill or software component may be used to assign work items to developers by work item management module 405 as described in method 200 of FIG. 2 and method 300 of FIG. 3. Developer classification module 422 may determine a classification for a developer based on an expertise score from expertise score calculation module 421. In some embodiments, the developer classification that is calculated by developer classification module 422 may be used to assign work items to developers as described in method 200 of FIG. 2 and method 300 of FIG. 3.

Expertise score vector 402N corresponds to a single developer in an organization. Expertise score vector 402N includes a developer and team identifier 430, which includes a unique identifier of the developer corresponding to expertise score vector 402N, and any teams that the developer is part of. A developer may be part of multiple teams in some embodiments. Expertise score vector 402N includes a plurality of data fields corresponding to the developer.

Expertise score vector 402N may include respective component mastery metrics 431A-N for each software component that the developer has contributed work to. Component mastery metrics 431A-N may include an amount of time required by the developer to produce a unit of contribution to the associated software component. The unit of contribution may be measured in any appropriate manner (e.g. task completed, or lines of code). A number of errors or defects found in committed code by, for example, code analysis module 407 and/or review and testing module 408, that is related to a specific software component may also be tracked. For example, a number of defects detected in code per unit of contribution (e.g., lines of code or number of tasks) for a specific software component may be stored in component mastery metrics 431A-N. The component mastery metrics 431A-N may also include an amount of time spent on the software component, and a total number of contributions made to the software component. Developer classification module 422 may classify the developer with respect to a specific software component based on a set of component mastery metrics 431A, or an overall component mastery metric corresponding to the specific software component. Work items may be assigned to the developer based on the classifications determined by developer classification module 422, and also based on the developer's work queue points from work queue points module 440.

Expertise score vector 402N may include a plurality of developer skill metrics 432A-N. Each individual set of developer skill metrics 432A-N may correspond to a specific skill (e.g., a programming language, a programming technique, such as recursion or multithreading, or a specific hardware element) possessed by the developer. Any appropriate metrics, including skill level and time spent on the skill, may be maintained in the developer skill metrics, such as developer skill metrics 432A, corresponding to a specific skill. Developer skill metrics 432A-N may be used in block 203 of method 200 of FIG. 2, and blocks 303 and 304 of method 300 of FIG. 3, to select developers to assign to a particular work item. The developer skill metrics 432A-N may include any appropriate metrics, including but not limited to a language set (e.g., Java, Python, C, etc.), coding techniques, and code patterns. Developer skill metrics 432A-N may track any appropriate particular techniques or technologies, including but not limited to recursion, loops, thread management, mutex locks, and interfacing with specific subcomponents. The developer skill metrics 432A-N may track a number of commits by the developer per skill to quantify an amount of experience the developer has regarding the skill. Errors in code committed that is related to the skill may also be tracked. A number of errors or defects found in committed code by, for example, code analysis module 407 and/or review and testing module 408, that are related to the skill may also be tracked. For example, a number of defects detected in code per unit of contribution (e.g., lines of code or number of tasks) for a specific skill may be stored in developer skill metrics 432A-N. A code contribution by the developer may be scanned by code analysis module 407 (using, for example, static code analysis and/or NLP) to identify what the code does and any techniques that are implemented in the code contribution, and the developer skill metrics 432A-N may be updated based on the scanning. Expertise score vector 402N may also include code quality metrics 433, problem records metrics 434, regression testing metrics 435, and code review change metrics 436.

It is to be understood that the block diagram of FIG. 4B is not intended to indicate that the expertise score vector module 401 is to include all of the components shown in FIG. 4B. Rather, the expertise score vector module 401 can include any appropriate fewer or additional components not illustrated in FIG. 4B (e.g., additional memory components, embedded controllers, functional blocks, connections between functional blocks, modules, inputs, outputs, etc.). Further, the embodiments described herein with respect to expertise score vector module 401 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments. Further, expertise score vector 402N is shown for illustrative purposes only. Embodiments of an expertise score vector such as expertise score vector 402N may include any appropriate number and type of data fields in various embodiments.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

One or more of the methods described herein can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description, but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving, by a processor, a problem record corresponding to a software component;
determining a work item corresponding to the problem record;
assigning the work item to a developer based on an expertise score vector of the developer; and
based on completion of the work item by the developer, updating the expertise score vector of the developer.

2. The computer-implemented method of claim 1, comprising:
based on assigning the work item to the developer, determining a review and testing process for the work item based on the expertise score vector of the developer; and
based on completion of the work item by the developer, applying the determined review and testing process to computer code corresponding to the work item, wherein the expertise score vector of the developer is updated based on the applied review and testing process.

3. The computer-implemented method of claim 2, wherein determining the review and testing process comprises determining a number of review and testing iterations to apply to the computer code.

4. The computer-implemented method of claim 1, wherein a work queue points module tracks a currently assigned workload of the developer, and wherein the work item is assigned to the developer based on the work queue points module.

5. The computer-implemented method of claim 1, wherein the expertise score vector comprises a skillset of the developer, and wherein the work item is assigned to the developer based on matching the skillset to keywords from the problem record.

6. The computer-implemented method of claim 1, wherein the work item corresponds to a desired skill that is included in the expertise score vector of the developer, and further comprising:
selecting an additional developer to assign to the work item with the developer based on an expertise score vector of the additional developer not including the desired skill.

7. The computer-implemented method of claim 6, comprising updating the expertise score vector of the additional developer to include the desired skill based on completion of the work item.

8. A system comprising:
a memory having computer readable instructions; and
one or more processors for executing the computer readable instructions, the computer readable instructions controlling the one or more processors to perform operations comprising:
receiving a problem record corresponding to a software component;
determining a work item corresponding to the problem record;
assigning the work item to a developer based on an expertise score vector of the developer; and
based on completion of the work item by the developer, updating the expertise score vector of the developer.

9. The system of claim 8, comprising:
based on assigning the work item to the developer, determining a review and testing process for the work item based on the expertise score vector of the developer; and
based on completion of the work item by the developer, applying the determined review and testing process to computer code corresponding to the work item, wherein the expertise score vector of the developer is updated based on the applied review and testing process.

10. The system of claim 9, wherein determining the review and testing process comprises determining a number of review and testing iterations to apply to the computer code.

11. The system of claim 8, wherein a work queue points module tracks a currently assigned workload of the developer, and wherein the work item is assigned to the developer based on the work queue points module.

12. The system of claim 8, wherein the expertise score vector comprises a skillset of the developer, and wherein the work item is assigned to the developer based on matching the skillset to keywords from the problem record.

13. The system of claim 8, wherein the work item corresponds to a desired skill that is included in the expertise score vector of the developer, and further comprising:
selecting an additional developer to assign to the work item with the developer based on an expertise score vector of the additional developer not including the desired skill.

14. The system of claim 13, comprising updating the expertise score vector of the additional developer to include the desired skill based on completion of the work item.

15. A computer program product comprising a computer readable storage medium having program instructions embodied therewith, the program instructions executable by a processor to cause the processor to perform operations comprising:
receiving a problem record corresponding to a software component;
determining a work item corresponding to the problem record;
assigning the work item to a developer based on an expertise score vector of the developer; and
based on completion of the work item by the developer, updating the expertise score vector of the developer.

16. The computer program product of claim 15, comprising:
based on assigning the work item to the developer, determining a review and testing process for the work item based on the expertise score vector of the developer; and
based on completion of the work item by the developer, applying the determined review and testing process to computer code corresponding to the work item, wherein the expertise score vector of the developer is updated based on the applied review and testing process.

17. The computer program product of claim 16, wherein determining the review and testing process comprises determining a number of review and testing iterations to apply to the computer code.

18. The computer program product of claim 15, wherein a work queue points module tracks a currently assigned workload of the developer, and wherein the work item is assigned to the developer based on the work queue points module.

19. The computer program product of claim 15, wherein the expertise score vector comprises a skillset of the developer, and wherein the work item is assigned to the developer based on matching the skillset to keywords from the problem record.

20. The computer program product of claim 15, wherein the work item corresponds to a desired skill that is included in the expertise score vector of the developer, and further comprising:
selecting an additional developer to assign to the work item with the developer based on an expertise score vector of the additional developer not including the desired skill.
